(19) United States
(12) Patent Application Publication
(10) Pub. No.: US 2005/0276927 A1
(43) Pub. Date: Dec. 15, 2005

(54) Method for forming wooden decorating plate with strip-like texture

(76) Inventor: Teng-Chen Ko, Changhua (TW)

Correspondence Address: KO TENG-CHEN, 235 CHUNG-HO BOX 8-24, TAIPEI HSIEN, 235, TW

(21) Appl. No.: 10/867,416

(22) Filed: Jun. 15, 2004

(51) Int. Cl. B05D 5/00; B05D 7/00

(52) U.S. Cl. 427/428.01; 427/402

(57) ABSTRACT

A method for forming wooden decorating plate with strip-like texture comprises the steps of: rolling a roller with strip-like texture thereon through a wooden plate so that the texture is formed on a surface of the wooden plate; paint shading color in recesses of the texture so that protruding portions of the texture on the wooden plate present the original colors of the wooden plate and the recesses have deep colors, and thus the wooden plate presents a strong three dimensional sense; coating transparent resin on the surface of the wooden plate so as to form a smooth protecting layer to the wooden plate; and cutting the wooden plate into at least one decorating plate. The manufacturing process of the present invention is easy and convenient.

### FIELD OF THE INVENTION

The present invention is related to decorating wood plates, and particularly to a method for forming wooden decorating plate with strip-like texture.

### BACKGROUND OF THE INVENTION

Conventionally, wooden plate with decorating strip like texture are formed by fabricating piece by piece and the edges of the plate must be trimmed. The manufacturing process is tedious and the cost is high. Thereby a large amount of waste material is generated. Thus, there is an eager demand for a novel method which can improve the defect in the prior art.

### SUMMARY OF THE INVENTION

Accordingly, the primary object of the present invention is to provide a method for forming wooden decorating plate with strip-like texture which comprises the steps of: rolling a roller with strip-like texture thereon through a wooden plate so that the texture is formed on a surface of the wooden plate; paint shading color in recesses of the texture so that protruding portions of the texture on the wooden plate present the original color of the wooden plate and the recesses has deep colors, so that the wooden plate presents a strong three dimensional sense; coating transparent resin on the surface of the wooden plate so as to form a smooth protecting layer to the wooden plate; and cutting the wooden plate into at least one decorating plate. The manufacturing process of the present invention is easy and convenient.

The various objects and advantages of the present invention will be more readily understood from the following detailed description when read in conjunction with the appended drawing.

### BRIEF DESCRIPTION OF THE DRAWINGS

FIG. 1 shows the manufacturing process of the present invention.

FIG. 2 shows the flow of the product of the present invention.

FIG. 3 shows a perspective view of the product according to the present invention.

FIG. 3A is a partial enlarged view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

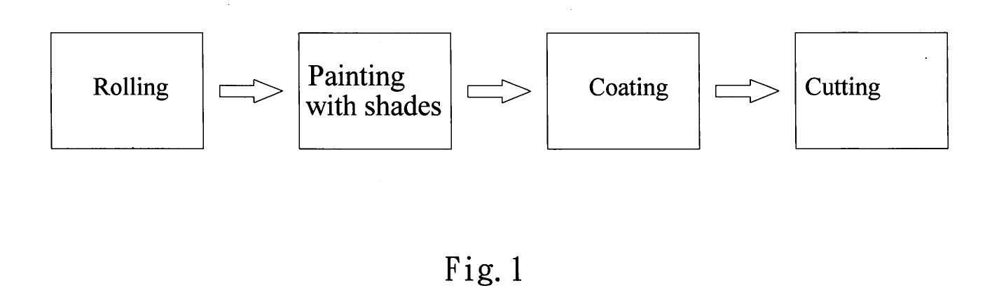

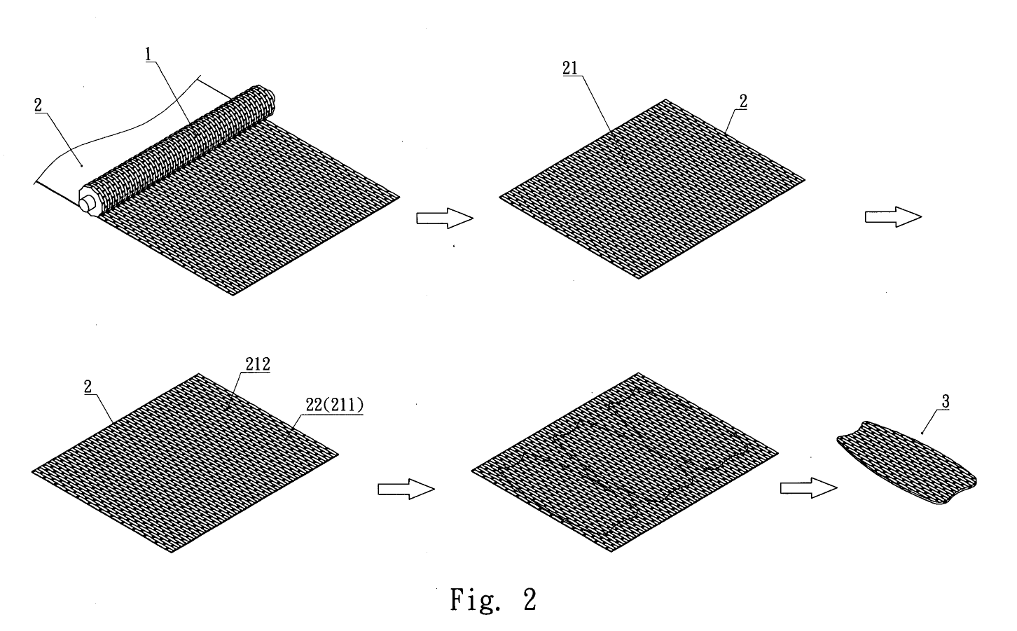

Referring to FIG. 1 to 3, the process of the present invention comprises the following steps.

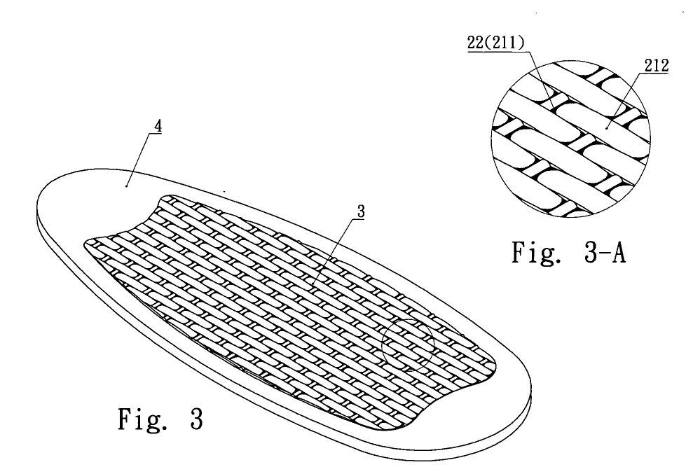

Rolling a roller 1 with strip-like texture 21 thereon through a wooden plate 2 so that the texture 21 is formed on a surface of the wooden plate 2. Paint shading color 22 in recesses 211 of the texture 21 so that protruding portions of the texture 21 on the wooden plate 2 present the original color of the wooden plate and the recesses 211 have deep colors 22, see FIG. 3A so that the wooden plate 2 presents a strong three dimensional sense.

Coating transparent resin on the surface of the wooden plate 2 so as to form a smooth protecting layer to the wooden plate 2.

Cutting the wooden plate 2 into at least one decorating plate 3, for example, a blade 4 of a ceiling fan, see FIG. 3. Thus, in the present invention, the strip-like texture 21 is directly printed on the wooden plate 2 and then the recesses of the texture 21 are painted with shading color 22 so as to present a beautiful three dimensional structure. Then a layer of resin is coated on the wooden plate 2 as a protecting layer. Then the wooden plate 2 is cut to a desired size as a decorating plate 3. The manufacturing process of the present invention is easy and convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for forming wooden decorating plate with strip-like texture, comprising the steps of:
rolling a roller with strip-like texture thereon through a wooden plate so that the texture is formed on a surface of the wooden plate;
paint shading color in recesses of the texture on the surface of the wooden plate so that protruding portions of the texture on the wooden plate present original colors of the wooden plate and the recesses have deep colors, and thus the wooden plate presents a strong three dimensional sense;
coating transparent resin on the surface of the wooden plate so as to form a smooth protecting layer to the wooden plate; and
cutting the wooden plate into at least one decorating plate.
